(19) United States
(12) Patent Application Publication
(10) Pub. No.: US 2012/0119415 A1
(43) Pub. Date: May 17, 2012

(54) Improvements in Aircraft Seats and Related Components

(76) Inventor: Gary Seale, Shrewsbury (GB)

(21) Appl. No.: 13/262,556

(22) PCT Filed: Mar. 31, 2010
(86) PCT No.: PCT/GB2010/000679

§ 371 Date: Dec. 21, 2011

(30) Foreign Application Priority Data
Mar. 31, 2009 (GB) 0905538.5

(51) Int. Cl. B64D 11/06; B60R 22/00; B29C 45/14; B60N 2/01; B29C 65/70

(52) U.S. Cl. 264/261; 297/248; 244/119; 297/216.16; 264/271.1; 24/591.1

(57) ABSTRACT

In one aspect, an aircraft seat assembly comprises a plurality of seat skeleton parts (22-26, 36,38) held in juxtaposition with one another by means of an over-moulded polymer material (42). In another aspect an aircraft seat assembly comprises a seat back portion having an expanded polymer material over-moulded over a seat skeleton part (14), the seat back portion having posterior recesses (38) that allow additional knee-space for a passenger seated in a seat behind. In another aspect an interior structural component of an aircraft comprises a moulded polymer encapsulated by a metallic flashing.

The present invention relates to components used in aircraft, and particularly, but not exclusively, to an aircraft seat assembly, for example a passenger seat assembly for commercial aircraft.

As air travel continues to increase, so do the demands placed on aircraft designers and operators to increase the passenger payload (i.e. the number of passengers that a given aircraft can carry). Two of the factors that limit passenger payload are weight and seating space. Many components used inside aircraft still make use of metals in their construction. The reason for this is usually because the component must have a certain strength. Even low-density metals, such as aluminium and aluminium alloys are more than twice as dense as some polymer-based composite materials. However, other factors, such as the requirements of flammability, gas and toxicity of components that are used inside aircraft have prevented wider exploitation of polymer-based materials.

Conventionally, to satisfy structural design and passenger comfort requirements, aircraft passenger seats have been manufactured using relatively heavy and bulky materials, including, for example, metal components such as supporting struts and fasteners. These materials and components contribute a significant amount to the overall weight of a commercial aircraft, particularly where there is seating for hundreds of passengers. Reducing the weight of the structural parts of an aircraft may allow the aircraft to carry more fuel, thus extending the flight range, or to carry more passengers and/or cargo. As well as the seat base, back and supporting legs, aircraft seats include additional components, such as seat belts, arm-rests, trays and pockets for stowing magazines or other items that passengers use in-flight. Many of these additional components are secured using relatively heavy metal fasteners. WO 85/02384 describes an aircraft seat formed of a resin-impregnated carbon fibre material and WO 2007/136578 describes aircraft seat assemblies that use composite materials in order to reduce the weight of the seats. However, these seats still require assembling using a variety of metallic fasteners.

Passenger comfort, especially the amount of legroom between rows of seats is another important consideration. In this regard, the bulky materials used in conventional aircraft passenger seats take up a significant proportion of the row-to-row spacing of the seats so that leg-room is reduced to a bare minimum in order to fit in the maximum possible number of rows in a passenger cabin. Alternatively passenger payload is reduced in the interests of passenger comfort.

A further problem with prior art aircraft seat constructions arises from the relative complexity in the manufacturing processes. The seats have to be assembled from a relatively large number of components that are fitted together using fasteners, most of which are necessarily heavy metallic (e.g. steel) fasteners to provide the required strength.

The present invention has been conceived with the foregoing in mind.

According to a first aspect of the present invention there is provided an aircraft seat assembly comprising a plurality of seat skeleton parts held in juxtaposition with one another by means of an over-moulded polymer material.

In embodiments of the invention the aircraft seat assembly comprises a seat back portion having an expanded polymer material over-moulded over a seat skeleton part, the seat back portion having posterior recesses that allow additional knee-space for a passenger seated in a seat behind.

It is an advantage that the scalloped shape can be formed using an over-moulding process to increase leg-room for improved passenger comfort, while maintaining a minimal row-to-row spacing of seats.

The over-moulded polymer material may be an expanded polymer material, such as expanded polypropylene.

The seat skeleton parts may comprise a seat back skeleton and a seat base skeleton. The seat back skeleton may have a shape that includes a bottom portion with one or more recesses, channels or openings, while the seat base skeleton may have a rear portion with a shape that corresponds with the shape of the bottom portion of the seat back skeleton. One or more of the seat skeleton parts may be a moulded part formed of a plastics material.

It is an advantage that at least the seat back and base is formed as a single over-moulded component, avoiding the need for heavy metallic fasteners. The shape of the skeleton parts allows for optimal strength in the over-moulded assembly. It is a further advantage that no further assembly operation is required for these moulded components.

Embodiments may further comprise a leg part, which may be over-moulded with the polymer material. The leg part may comprise a layer of an expanded form material over-moulded with said polymer material. At least one region of the expanded form material may be removed to form an opening. It is an advantage that the amount of material used in the leg can be reduced to a minimum by removing regions of excess material that are not required to provide the necessary structural support.

Embodiments may further comprise an energy absorber for damping movement of the seat relative to the aircraft, wherein at least a portion of the energy absorber is attached to the leg part by means of the over-moulded polymer material.

Embodiments may further comprise a seat bolster having an inner core form and an outer over-moulded expanded polymer form. Advantageously, the seat bolster is removable for use as a buoyancy aid. The seat bolster may include straps that are held in position by the over-moulded expanded polymer material.

The skeleton parts may further comprise a seat belt anchorage.

Embodiments may further comprise one or more of an arm rest, and a pocket back moulding and/or a tray for use by a passenger seated in a seat behind.

Embodiments may comprise a plurality of seats adjoined side-by-side in a row.

According to a second aspect of the present invention there is provided a method of manufacturing an aircraft seat assembly. The method comprises: forming a plurality of seat skeleton parts, comprising at least a seat back skeleton; and over-moulding a polymer material over said seat skeleton parts, the skeleton parts being held in juxtaposition with one another by said polymer material without the use of separate fastening means.

The method may further comprise: moulding a seat back skeleton in a shape that includes a lower portion having one or more recesses, channels or openings; moulding a seat base skeleton in a shape that includes a rear portion having a shape that corresponds with the shape of the bottom portion of the seat back skeleton; and positioning the seat back skeleton and seat base skeleton into a seat mould prior to over-moulding the polymer material.

Forming the seat back skeleton may comprise moulding a seat back skeleton in a shape that includes a lower portion having scalloped recesses. The over-moulding may comprise positioning the seat back skeleton into a mould; over-moulding a polymer material over the seat back skeleton to form a seat back with recesses that allow additional knee-space for a passenger seated in a seat behind. the method may further comprise securing the seat back into a seat assembly without the use of separate fastening means.

It is an advantage that the methods according to the invention involve the forming of a seat, including at least the seat back, in a single over-moulding operation. Avoiding the use of separate fasteners means that no separate assembly of these components is required as well as resulting in a lighter weight of seat.

According to a further aspect of the present invention there is provided an interior structural component of an aircraft, comprising a moulded polymer encapsulated by a metallic flashing.

The moulded polymer may comprise polyamides or amorphous or non-amorphous polymer groups, especially those though that exhibit high structural performance levels.

The metallic flashing may comprise copper, nickel, or other metals, including more decorative metals or precious metals such as chromium, silver or gold.

In embodiments of the invention, the metallic flashing may have a thickness of less than 0.2 mm. Preferably, the metallic flashing has a thickness of less than 20 μm. However where application of the flashing is a time based process, thicker coatings up to or in excess of 2 mm can be produced for extreme applications.

The metallic flashing may be an over-moulded flashing. Alternatively, the metallic flashing may be a chemically-deposited flashing.

Examples of the interior structural component include a seat belt buckle, seat leg or any structural element more commonly manufactured from Aluminium or steel, for example retaining elements, slides, supports, or armrests.

It is an advantage that the metallic flashing encapsulating the polymer material conducts heat away from a flame and also prevents gases or toxic fumes being released by the polymer when subjected to heat of flame conditions. This means that the light-weight polymer component (typically weighing less than half that of a corresponding aluminium component) can meet the demands of aircraft flammability, gas and toxicity standards.

According to a still further aspect of the present invention there is provided an aircraft seat belt comprising a buckle formed of a moulded polymer material encapsulated by a metallic flashing.

It is an advantage that a reduced weight of seat belt can be provided by avoiding the use of heavier metal materials, and that the over-moulding process reduces the amount of material required by avoiding the need for surplus material that is required when forming metal buckles using conventional pressing methods. The metallic flashing provides the impression that the buckle is similar to known metal buckles.

Embodiments of the aspects of the invention will be described with reference to the following accompanying drawings.

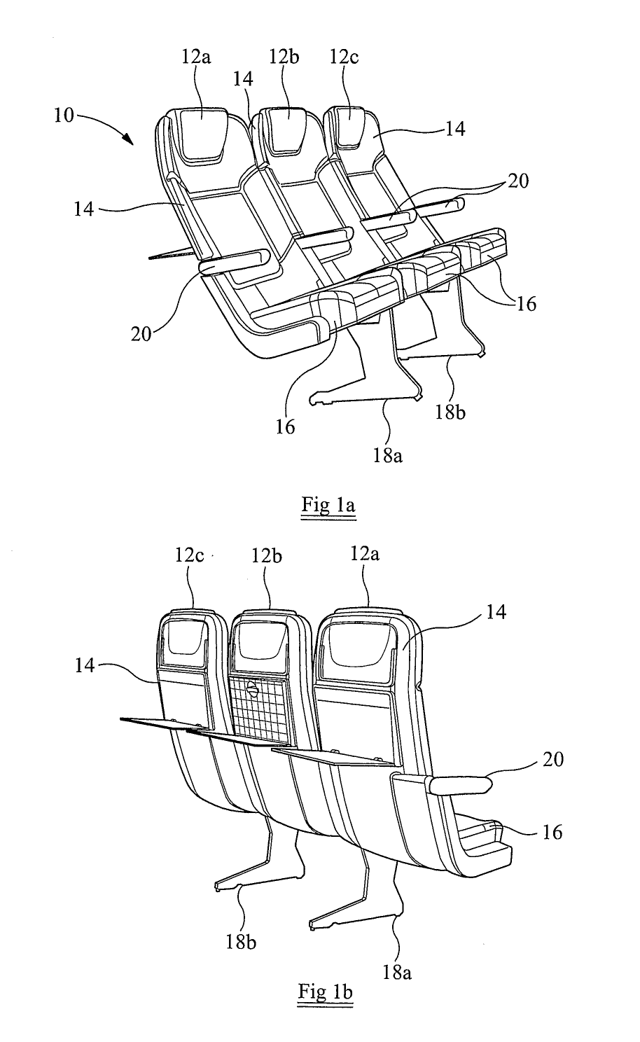

FIGS. 1A and 1B show respectively front and rear views of an aircraft seat assembly embodiment.

FIG. 2 is an exploded view showing some of the components used in the aircraft seat assembly of FIG. 1.

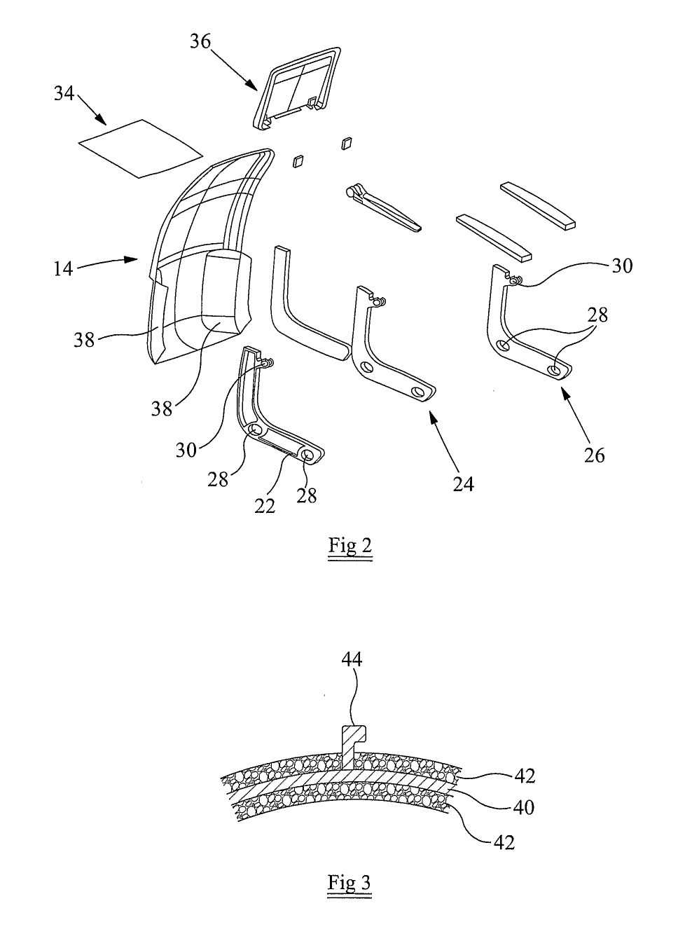

FIG. 3 is an illustrative cross-section of part of an over-moulded seat component.

FIG. 4 is an illustration of skeleton components forming part of an aircraft seat assembly.

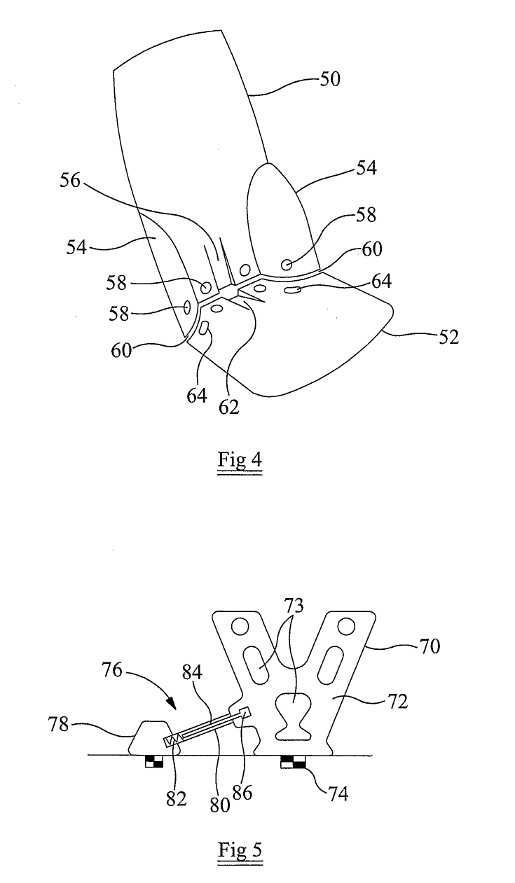

FIG. 5 is an illustration of a an aircraft seat leg assembly.

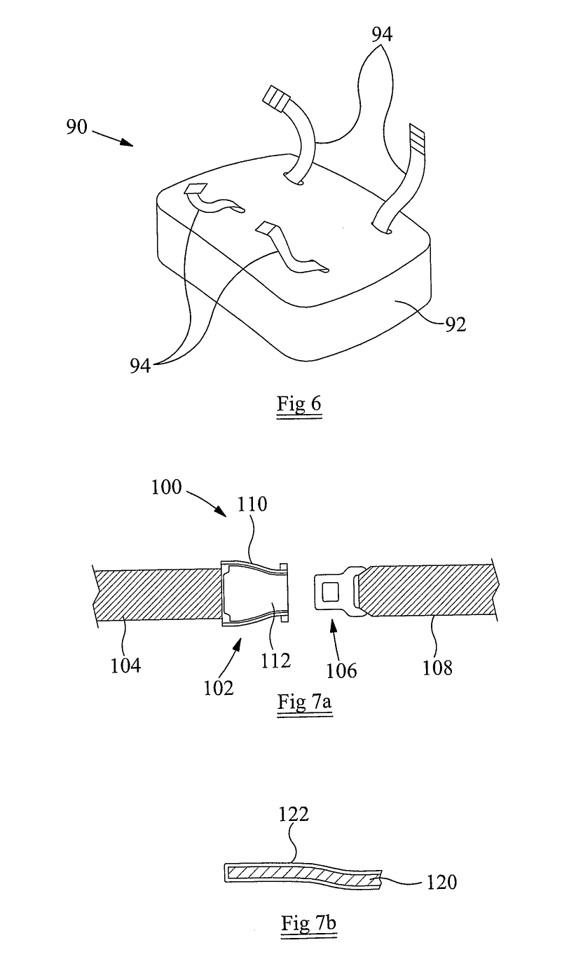

FIG. 6 is an illustration of an aircraft seat bolster.

FIG. 7 is an illustration of a seat belt buckle.

Referring to FIGS. 1A and 1B, an aircraft seat assembly 10 includes a row of three seats 12a, 12b, 12c. Although three seats are shown in this assembly, the principles described herein apply to an assembly of any number of seats in the row. The seats 12a, 12b, 12c each have a back 14 and a seat base 16. The seat assembly is supported above an aircraft cabin floor (not shown) by a pair of legs 18a, 18b. It will be appreciated that a minimum of two legs is required for any seat assembly, although more than two may be provided, especially if there are more seats in the assembly. Arm rests 20 are provided between each seat and at the ends of the row so that each seat has an arm rest 20 on each side.

Referring to FIG. 2, where the same reference numerals are used for the same components as in FIG. 1, each seat is mounted between a pair of frame members. Three such members are shown in FIG. 2: a right frame member 22, an inner frame member 24 and a left frame member 26. The right and left frame members 22, 26 are used on each end of a row of seats, while an inner frame member 24 is used between each pair of adjacent seats. The frame members 22, 24, 26 are generally L-shaped, with a generally horizontal arm and a generally vertical arm. The frame members 22, 24, 26 are formed of a moulded polymer, and each member includes openings 28 in the horizontal arm (which will be explained in more detail below) as well as a lug 30 near the tope of the vertical arm. An arm rest, which in the embodiment shown is made up of three interlocking moulded polymer pieces 32a, 32b, 32c, pivotally attaches to each of the lugs 30 on the frame members 22, 24, 26.

Each seat has a back 14, the construction of which will be explained in more detail below. In addition, a tray 34, again formed of a moulded polymer, can be mounted to the posterior of each seat back 14 and a further polymeric back moulding 36 can be attached to the back of the seat back 14 to provide a pocket for stowing magazines or other articles that a passenger may require in-flight.

The seat back 14 must meet certain requirements of safety and passenger comfort. It is for this reason that conventionally, aircraft seats have been built around a metal frame over which a significant thickness of soft padding is used to provide the required comfort. The thickness of the soft padding occupies space between each row of passengers and typically these aircraft seats have a mass in excess of 20 kg. To reduce both the amount of space and the mass of the seat assembly 10, the seat back 14 is formed using an over-moulding process. Over-moulding is a technique that was developed initially for moulding (e.g. injection moulding) of components having a shape that could not readily be formed in a single moulding operation. In this process a first moulding of a simpler, or pro-form shape is produced, and then the pro-form mounted inside a mould into which a material is injected or poured to produce a second, over-moulding for the more complex or intricate shapes. Overmoulding, by its very nature, is an intrinsic part of the injection mouding process whereby a core element or elements (e.g. pro-forms) can be partially or totally overmoulded with a polymer. Current technology allows for encapsulation of an element. In accordance with embodiments of the invention, the process may include three stages: in the first two stages a core component is formed and overmoulded with a light weight polymer as previously described. In the third stage (which will be described further below) the overmoulded component is coated with a metal layer or flashing.

FIG. 3 illustrates a simple cross-section through part of the seat back 14, which is constructed using an over-moulding process. First an inner skeleton form 40 is formed. The skeleton form 40 may itself be a moulded polymeric material, such as polypropylene. Alternatively, the skeleton 40 could be formed of sheet metal or any other suitably rigid material. The skeleton 40 is then over-moulded with a polymeric material 42. The polymeric material 42 may be an expanded polymer, such as expanded polypropylene (EPP). The skeleton 40 provides the required structural strength and rigidity for the seat back 14, while the over-moulded EPP provides a cushioning surround to the seat back, to improve the comfort. In this way, a seat back having the required structural integrity and comfort can be provided at a fraction of the weight and substantially thinner than conventional aircraft seats.

Another feature of the over-moulded design is that the shape of the seat back 14 can be optimised. In particular, the seat back 14 includes recesses 38 at either side of the lower part of the seat back, that allow additional knee-space for a passenger seated in a seat in the row behind. The spacing of the rows of aircraft seats is calculated based on a minimum distance taken on a line extending forwards at 45 degrees to the horizontal from the rear of the seat base at its centre-line to the back of the seat in front. However, this parameter does not properly account for the leg-room of a seat because a passenger's knees extend on either side of the centre-line. Thus, in the seats illustrated in FIGS. 1A, 1B and 2, as much as an additional 10 cm of space can be made available for the passenger's knees by the recesses 38, when compared with conventional seat designs. However, the shape of the recesses also helps to provide structural strength and rigidity to the over-moulded seat back 14.

In addition to over-moulding over and around the skeleton 40, additional features may be included in the over-moulding that further improve the seat design. By suitable positioning the over-moulding process can be used to connect additional components, such as component 44 shown in FIG. 3, to the seat back 14 in a single moulding operation, so that these components are structurally bound to the seat back 14 without the need for separate fasteners. The features may include, for example, connection brackets for connection to the frame members 22, 24, 26, tray 34 or back moulding 36, and anchorage points for securing a seat belt. The ability of the over-moulding technique to bind these features to the seat back 14 without separate fasteners (e.g. steel screws, rivets etc.) helps to further reduce the mass of the seat assembly.

This principle can be extended to incorporate not just brackets or interconnection features, but to connect the seat back 14 to other seat components such as a seat base, frame members or legs. For example, a single over-moulding process may be employed to produce a seat assembly that includes a seat back 14 and a seat base that supports a seat cushion or bolster. Another possibility is that the seat back 14 could be formed from two or more skeleton parts that are bound together with the required structural integrity when over-moulded. To provide the required structural strength when two or more skeleton parts are over-moulded together, requires careful design of the shapes of the skeleton parts. FIG. 4 illustrates one way that this can be achieved, in which a seat back skeleton 50 and seat base skeleton 52 are joined to each other to provide a unitary over-moulded seat. The seat back 50 includes not only recessed portions 54 on either side (as with the seat back 14 described above) but has a moulded shape that includes a channel section 56 and openings 58. The seat base skeleton 52 also includes corresponding cut-outs 60, channel 62 and openings 64. When the two skeleton parts 50, 52 are placed into a mould and over-moulded, the polymer material flows through and around the features and binds them together into a unitary seat having the required structural integrity and comfort.

The legs 18a, 18b illustrated in FIGS. 1A and 1B are formed of an expanded form material, for example a honeycomb structure, which may be formed of a polymer, synthetic fibre, metal or any other suitable material. An alternative leg structure 70 is shown in FIG. 5. In this case, the expanded form material is over-moulded with a polymer (for example EPP or EPS) 72. In addition, prior to over-moulding, the expanded form material is shaped so that excess material, in regions that are not required for providing structural support, is removed. As a result, the leg has regions that are cut away, and/or openings 73 through the leg form. The resultant shape is then over-moulded. This provides a smooth outer surface to the leg, and also allows additional components such as anchorage points 74 and fixing brackets (not shown) to be attached to the leg by way of the over-moulding and without the need for separate fasteners.

As shown in FIG. 5, another component that is attached to the leg by the over-moulding is an energy absorber 76. Energy absorbers are used for damping movement of the seat relative to the aircraft in the event of a crash incident. The energy absorber 76 includes a buffer 78, which is anchored to the aircraft cabin floor, and a polymeric tube 80 that extends towards the seat leg 70. Inside the tube, at the buffer end is a spring 82. A metal strut 84 extends inside the tube and is held to the set leg 70 by means of the over-moulded polymer material 72. The metal strut has an enlarged end 86 within the seat leg 70. The enlarged end 86 has a diameter that is a little larger than the inside diameter of the tube 80.

In the event of a crash incident in which the seat 70 is forced towards the energy absorber 76 by its momentum, this is initially resisted by the spring 82. However, further movement of the seat results in the tube 80 being pushed towards the seat leg until the enlarged end 86 is urged into end of the tube 80. Energy is absorbed at a high rate as the enlarged end 86 is pushed through the tube 80. Any portion of, or all of, the energy absorber components may be over-moulded with the same polymer 72 as the seat leg 70.

FIG. 6 illustrates a seat cushion or bolster 90. The bolster is formed using an over-moulding process as described above and includes an inner core form (not shown) and an outer over-moulded expanded polymer form 92. The inner core may be formed of a polymer such as polypropylene, while the outer over-moulded material may be an expanded polymer such as EPP or EPS. The seat bolster 90 is designed to simply rest on the aircraft seat base, although it preferably has a fairly tight fit to prevent the bolster moving during normal flight conditions. The bolster 90 therefore removable from the seat and can be used as a buoyancy aid, in the event that the aircraft is forced to put down over water. The seat bolster 90 is therefore formed with straps 94 that are held in position onto the inner core material by the over-moulded expanded polymer 92.

In accordance with aspects of the invention, the use of polymer materials can be applied to other components found inside an aircraft, but which have conventionally been formed largely or entirely from metal. Examples may include seat legs or any structural elements more commonly manufactured from aluminium or steel, such as retaining elements, slides, supports, or armrests. One example is shown in FIG. 7A, which illustrates a seat belt buckle 100 of the type commonly used in aircraft. The buckle includes a retainer portion 102 affixed to a first part 104 of the seat belt, and into which a tongue 106, affixed to a second part 108 of the seat belt, is inserted. The retainer portion 102 has a body 110 to which the first part 104 of seat belt is secured and a flap 112 pivotally attached to the body 110 and spring urged into a closed position in which the tongue 106 is retained in the retainer 102. In conventional aircraft seats, the retainer body 110 and flap 112 and the tongue 106 are all formed of pressed metal, such as steel, and are a relatively heavy components. One reason for this weight is that for the pressing operation to be performed correctly an excess of material is required (i.e. more than is required to provide the necessary strength).

The weight of the seat belt buckle, or other component, may be reduced by forming it from a suitable polymeric material using a moulding operation. Not only are polymers less dense than most metals, but the moulding process enables the component to be formed to precisely the dimensions required to provide the necessary strength, without the need for any excess material. However, one factor to consider is the impression of strength that is provided by the metal buckle, and the impression that plastics materials are not as strong. This prejudice may be overcome by use of a buckle, in which the parts are formed as shown in FIG. 7B. The buckle shape is formed of an injection-moulded polymer material 120, and is then over-moulded with a metallic flashing 122.

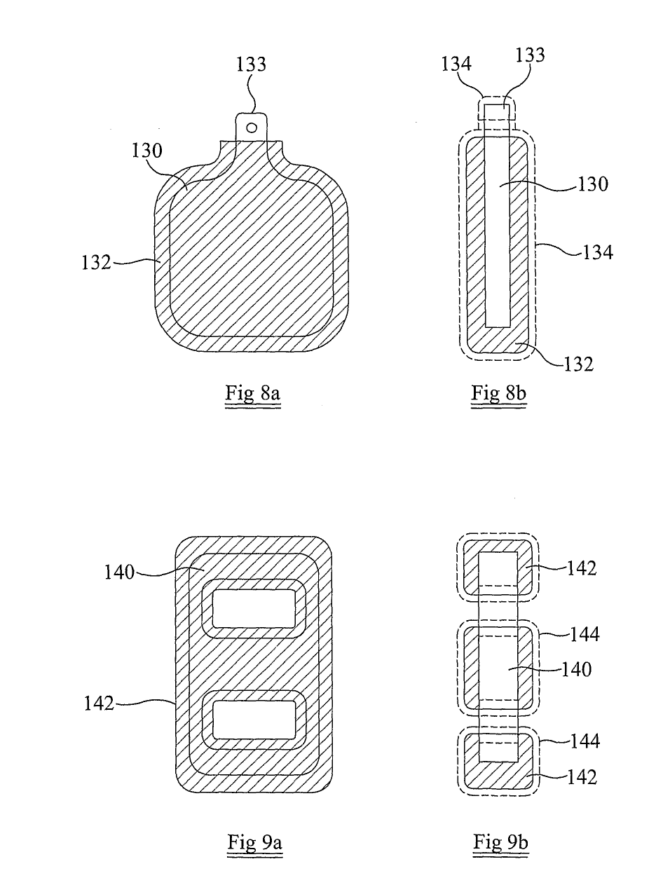

FIGS. 8A and 8B illustrate the overmoulding process. In FIG. 8A a polymer core element 130 has been formed, typically by an injection moulding operation. The core element 130 is then overmoulded with a further polymer material 132 (which may be the same or a different material to that of the core element 130) in a second injection moulding operation. As shown, a portion 133 of the core element 130 is left exposed in this operation, for example to provide an anchorage location for the component, although this may not be required in other components formed using this process. FIG. 8B, shows a side view in cross section of the same component onto which an outer metal layer or flashing 134 is coated around the component to encapsulate it. This coating operation may also involve an overmoulding In this case the entire component is encapsulated by the flashing 134. However, in other cases only part of the component (for example the exposed portion 133) might be coated with the metal flashing 134.

FIGS. 9A and 9B illustrate a similar overmoulding procedure for another component. In this case a core element 140 is totally encapsulated in overmoulded polymer material 142. The polymer material 142 may be provided, for example, to provide noise resistance or protection to the core element 140 from scuffing or other wear and tear, the core element providing the required structural strength of the component. Finally, the entire component is encapsulated in an overmoulded metallic flashing 144.

Alternatively, the metal flashing 134, 144 may be applied by means of a chemical deposition technique. In either case, the metal layer encapsulates the polymer material. The metal flashing is typically only a small fraction of a millimetre or a few micrometres thick, and does not add significantly to the weight of the polymer used to form the component. However, for some components a thicker metallic coating may be required, and thicknesses of up to 2 mm or more can be applied using these techniques (i.e. overmoulding or chemical deposition). The metallic flashing provides the impression that the buckle is similar to known metal buckles. The metallic flashing also allows the component to meet the stringent requirements of flammability, gas and toxicity. It has been found that, when subjected to a naked flame for up to 60 seconds (as required by certain standards) the metal flashing disperses the heat and limits the rate of rise of the temperature of the polymer. Also, any gaseous or toxic fumes that might be produced by heating the polymer are contained within encapsulating metallic flashing.

Another problem has been encountered with buckles such as that shown in FIG. 7A. In the event of an incident where passengers are required to evacuate the aircraft, a significant delay arises because passengers, especially when in a shocked or dazed condition, expect to release the seat belt in the same way as they would a standard car seat belt. It would therefore be possible, using a buckle formed of a moulded polymer to construct a release mechanism that more closely resembles that of a car seat belt, thereby overcoming this problem at the same time as reducing the weight of the buckle.

It will be appreciated that aspects of the invention provide a variety of ways in which weight (mass) may be reduced in aircraft components such as seat assemblies.

Typically a seat constructed in accordance with the principles of the invention weighs less than 10 kg, compared with more than 20 kg for a conventional aircraft seat.

1. An aircraft seat assembly comprising a plurality of seat skeleton parts held in juxtaposition with one another by means of an over-moulded polymer material, and including a leg part, wherein said leg part comprises a layer of an expanded form material over-moulded with said polymer material.

2. The aircraft seat assembly of claim 1, comprising a seat back portion having an expanded polymer material over-moulded over one or more of said seat skeleton parts, said seat back portion having posterior recesses that allow additional knee-space for a passenger seated in a seat behind.

3. The aircraft seat assembly of claim 1 wherein the over-moulded polymer material is an expanded polymer material, such as expanded polypropylene.

4. The aircraft seat assembly of claim 1 wherein the seat skeleton parts comprise a seat back skeleton and a seat base skeleton.

5. The aircraft seat assembly of claim 4 wherein the seat back skeleton has a shape that includes a lower portion with one or more recesses, channels or openings, and wherein the seat base skeleton has a rear portion with a shape that corresponds with the shape of the bottom portion of the seat back skeleton.

6. The aircraft seat assembly of claim 1 wherein one or more of the seat skeleton parts are moulded of a polymer material.

7-10. (canceled)

11. The aircraft seat assembly of claim 1 wherein at least one region of the expanded form material is removed to form an opening.

12. The aircraft seat assembly of any of claim 1, further comprising an energy absorber for damping movement of the seat relative to the aircraft, wherein at least a portion of the energy absorber is attached to the leg part by means of the over-moulded polymer material.

13-18. (canceled)

19. A method of manufacturing an aircraft seat assembly, the method comprising:
forming a plurality of seat skeleton parts, comprising at least a seat back skeleton formed by moulding the seat back skeleton in a shape that includes a lower portion having scalloped recesses; and
over-moulding a polymer material over said seat skeleton parts, the skeleton parts being held in juxtaposition with one another by said polymer material without the use of separate fastening means,
wherein the over-moulding comprises
positioning the seat back skeleton into a mould; and
over-moulding a polymer material over said seat back skeleton to form a seat back with recesses that allow additional knee-space for a passenger seated in a seat behind; and wherein the method further comprises
securing the seat back into a seat assembly without the use of separate fastening means.

20. The method of claim 19 further comprising:
moulding the seat back skeleton in a shape that includes a lower portion having one or more recesses, channels or openings;
moulding a seat base skeleton in a shape that includes a rear portion having a shape that corresponds with the shape of the bottom portion of the seat back skeleton; and
positioning the seat back skeleton and seat base skeleton into a seat mould prior to over-moulding the polymer material.

21. (canceled)

22. An interior structural component of an aircraft, comprising a moulded polymer encapsulated by a metallic flashing.

23. The interior structural component of claim 22, wherein the moulded polymer comprises one or more of polyamides, amorphous polymer groups, and non-amorphous polymer groups.

24. The interior structural component of claim 22 wherein the metallic flashing comprises a metal selected from: copper, nickel, a decorative metal, a precious metal, chromium, silver and gold.

25-28. (canceled)

29. The interior structural component of claims 22, wherein the metallic flashing is an over-moulded flashing.

30. The interior structural component of any of claims claims 22, wherein the metallic flashing is a chemically-deposited flashing.

31. The interior structural component of claim 22, wherein the component is a seat belt buckle.

32. (canceled)

33. A method of forming an interior structural component of an aircraft, the method comprising:
a) providing a core element;
b) overmoulding a polymer material over said core element; and
c) coating a metallic flashing over the structure resulting from step (b) to encapsulate at least a portion of said structure.

34. The method of claim 33 wherein the metallic flashing is coated in an overmoulding process.

35. The method of claim 33 wherein the metallic flashing is coated by a chemical deposition process.

36. The method of claim 33 further comprising forming the core element of a polymer in a moulding process.

37. The method of claim 33 wherein any or all of the moulding process and the overmoulding processes comprise injection moulding.

38. The interior structural component of claim 22 further comprising a first core component overmoulded with a polymer material, wherein the moulded polymer encapsulated by a metallic flashing is one of: the overmoulded polymer material, a part of the core component, and both the overmoulded polymer material and a part of the core component.

39. The method of claim 33 wherein a portion of the polymer core element is left exposed in the overmoulding step.

40. The method of claim 33 wherein the polymer core element is totally encapsulated by the polymer material in the overmoulding step.
